(19) United States
(12) Patent Application Publication
(10) Pub. No.: US 2023/0388857 A1
(43) Pub. Date: Nov. 30, 2023

(54) BASE STATION DEVICE, RADIO COMMUNICATION SYSTEM, AND RADIO COMMUNICATION METHOD

(71) Applicant: FUJITSU LIMITED, Kawasaki-shi (JP)

(72) Inventor: Kimihisa AKAZAWA, Kawasaki (JP)

(73) Assignee: FUJITSU LIMITED, Kawasaki-shi (JP)

(21) Appl. No.: 18/233,930

(22) Filed: Aug. 15, 2023

Related U.S. Application Data
(63) Continuation of application No. PCT/JP2021/013902, filed on Mar. 31, 2021.

(51) Int. Cl. H04W 28/12

(52) U.S. Cl. CPC H04W 28/12

(57) ABSTRACT

A base station device includes a processor and transmits data to a terminal using an adjacent base station. The processor transmits, to the adjacent base station at a specified cycle, a report request that requests a status report indicating a status of a data transmission from the adjacent base station to the terminal. The processor controls a data transmission to the adjacent base station based on the status report received from the adjacent base station. The processor changes the cycle of transmitting the report request to the adjacent base station based on a change in the status indicated by the status report.

### CROSS-REFERENCE TO RELATED APPLICATION

This application is a continuation application of International Application PCT/JP2021/013902 filed on Mar. 31, 2021, and designated the U.S., the entire contents of which are incorporated herein by reference.

### FIELD

The embodiments discussed herein are related to a base station device, a radio communication system, and a radio communication method.

### BACKGROUND

Dual connectivity has been discussed as one of the technologies to improve the average throughput of downlink. The dual connectivity is achieved by a plurality of base stations. For example, a master base station divides user data D into data D1 and data D2. The data D1 is transmitted to a user terminal and the data D2 is transmitted to a secondary base station. Then, the secondary base station transmits the data D2 to the user terminal. Thus, the user terminal obtains the user data D.

When transmitting downlink data in the dual connectivity, the master base station and the secondary base station perform the Downlink Data Delivery Status (DDDS) procedure. For example, the master base station requests the secondary base station for a DDDS report. In response to this request, the secondary base station transmits the DDDS report to the master base station. Then, the master base station performs a flow control of the downlink data based on the DDDS report.

Note that the dual connectivity is described in International Publication Pamphlet No. WO2020/026835 and International Publication Pamphlet No. WO2019/097705, for example.

The DDDS procedure is performed for each bearer. Therefore, as the number of bearers accommodated in the base station increases, the resources necessary to perform the DDDS procedure (for example, the capacity of CPU) increases. As a result, in the case of the base station having insufficient processing capacity, the transmission rate (or user throughput) of a user plane may be limited.

### SUMMARY

According to an aspect of the embodiments, a base station device includes a processor and transmits data to a terminal using an adjacent base station. The processor transmits, to the adjacent base station at a specified cycle, a report request that requests a status report indicating a status of a data transmission from the adjacent base station to the terminal. The processor controls a data transmission to the adjacent base station based on the status report received from the adjacent base station. The processor changes the cycle of transmitting the report request to the adjacent base station based on a change in the status indicated by the status report.

The object and advantages of the disclosure will be realized and attained by means of the elements and combinations particularly pointed out in the claims.

It is to be understood that both the foregoing general description and the following detailed description are exemplary and explanatory and are not restrictive of the disclosure.

### BRIEF DESCRIPTION OF DRAWINGS

FIG. 1 illustrates an example of a radio communication system according to an embodiment of the present disclosure.

FIG. 2 illustrates a configuration example of a radio protocol of base stations.

FIG. 3 illustrates an example of an operation sequence of dual connectivity.

FIGS. 4A and 4B illustrate an example of configurations of the base stations.

FIG. 5 illustrates an example of a format of a DDDS report.

FIGS. 6A-6C illustrate an example of a DDDS procedure according to a first embodiment of the present disclosure.

FIG. 7 illustrates an example of the DDDS procedure according to a second embodiment of the present disclosure.

FIG. 8 is a flowchart illustrating an example of an operation of a master base station according to the second embodiment.

FIG. 9 illustrates an example of the DDDS procedure according to a third embodiment of the present disclosure.

FIG. 10 illustrates an example of a radio rate estimated based on the DDDS report.

FIG. 11 is a flowchart illustrating an example of an operation of the master base station according to the third embodiment.

FIG. 12 illustrates an example of the DDDS procedure according to a fourth embodiment of the present disclosure.

FIG. 13 illustrates an example of a format of the DDDS report including a buffer report bit.

FIG. 14 is a flowchart illustrating an example of an operation of the secondary base station according to the fourth embodiment.

FIG. 15 is a flowchart illustrating an example of an operation of the master base station according to the fourth embodiment.

FIG. 16 illustrates an example of the DDDS procedure according to a fifth embodiment of the present disclosure.

FIG. 17 illustrates an example of a format of the DDDS report that may multiplex a plurality of bearers.

FIG. 18 is a flowchart illustrating an example of an operation of the secondary base station according to the fifth embodiment.

FIG. 19 illustrates an example of the DDDS procedure according to a sixth embodiment of the present disclosure.

FIG. 20 is a flowchart illustrating an example of an operation of the master base station according to the sixth embodiment.

### DESCRIPTION OF EMBODIMENTS

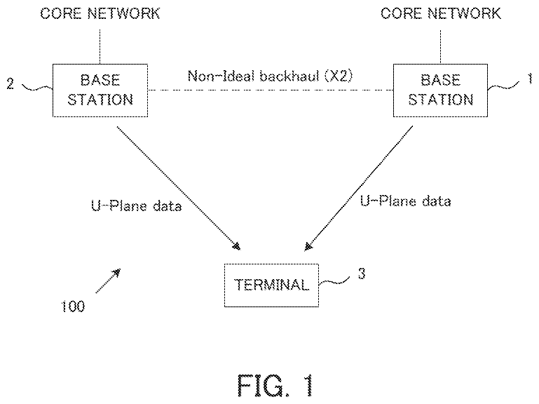

FIG. 1 illustrates an example of a radio communication system according to an embodiment of the present disclosure. A radio communication system 100 according to the embodiment of the present disclosure provides dual connectivity. The dual connectivity transports packet data between one terminal device (for example, UE) and two base stations.

The base station 1 is gNB in this example and operates as a master base station. In addition, the base station 2 is eNB in this example and operates as a secondary base station. The base stations 1 and 2 are connected via a Non-Ideal backhaul (for example, X2) interface. A user terminal 3 is a user equipment (UE) in this example. Then, the user terminal 3 may communicate with the base stations 1 and 2. The user terminal 3 may receive downlink data from both of the base stations 1 and 2 at the same time.

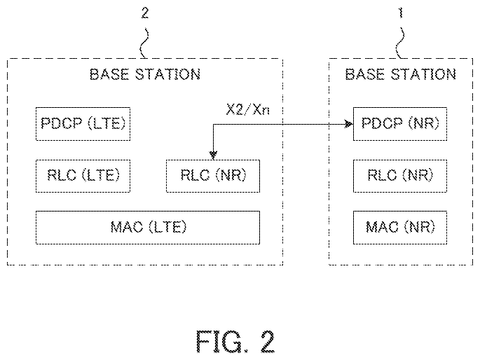

FIG. 2 illustrates a configuration example of a radio protocol of the base stations. In this example, a split bearer architecture achieves the dual connectivity.

The base stations 1 and 2 include a Packet Data Convergence Protocol (PDCP) layer, a Radio Link Control (RLC) layer, and a Medium Access Control (MAC) layer. The base station 2, which operates as the secondary base station, includes an RLC layer of Long Term Evolution (LTE) and an RLC layer of New Radio (NR). The PDCP layer of the base station 1 and the RLC layer of the base station 2 are connected via the X2 (Xn) interface.

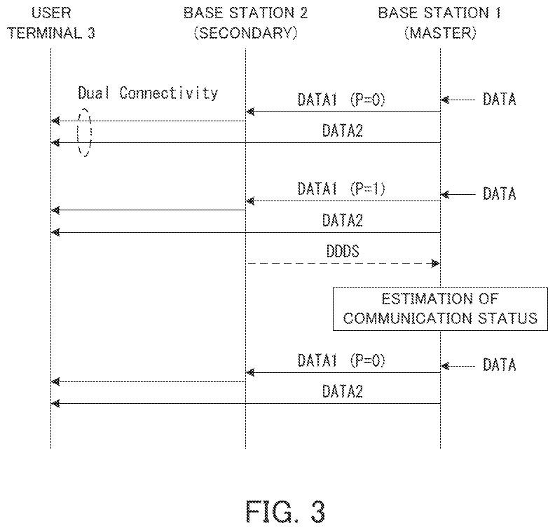

FIG. 3 illustrates an example of the operation sequence of the dual connectivity. In this example, the base station 1 operates as the master base station and the base station 2 operates as the secondary base station. In addition, downlink data transmitted from a core network to the user terminal 3 is provided to the user terminal 3.

The base station 1 divides the user data provided from the core network into DATA 1 and DATA 2. Then, the base station 1 transmits the DATA 1 to the base station 2 and the DATA 2 to the user terminal 3. The base station 2 forwards the DATA 1 received from the base station 1 to the user terminal 3. As a result, the user terminal 3 receives the DATA 1 and the DATA 2 and regenerates the DATA. Thus, the dual connectivity is achieved.

The base stations 1 and 2 perform the Downlink Data Delivery Status (DDDS) procedure to control a data transmission between the base stations 1 and 2. In other words, data packet transmitted from the base station 1 to the base station 2 is provided with a polling bit (P in FIG. 3). The polling bit indicates whether to request a DDDS report indicating the status of the data transmission from the base station 2 to the user terminal 3. Specifically, when the polling bit is “0”, the base station 2 transmits no DDDS report to the base station 1. When the polling bit is “1”, the base station 2 transmits the DDDS report to the base station 1.

The base station 1 requests the base station 2 for the DDDS report at a specified cycle. The specified cycle is indicated by, for example, the number of data packets transmitted from the base station 1 to the base station 2. By way of example, it is assumed that one DDDS report is necessary for 100 data packets. In this case, each of the 1st to 99th data packets is provided with “P=0”, and the 100th data packet is provided with “P=1”. In addition, each of the 101th to 199th data packets is provided with “P=0”, and the 200th data packet is provided with “P=1”.

The base station 1 estimates the status of the data transmission from the base station 2 to the user terminal 3 based on the DDDS report. For example, the radio condition between the base station 2 and user terminal 3 and the status of a data buffer of the base station 2 or the like are estimated. Then, the base station 1 controls the data transmission to the base station 2 based on the newly estimated status. For example, when a quality of the data transmission from the base station 2 to the user terminal 3 is good, the base station 1 may increase a data rate of the transmission to the base station 2.

The above described DDDS procedure is performed for each bearer. In the following description, the bearer corresponds to the path of the data packet. Therefore, in the case of the base stations 1 and 2 respectively accommodating a large number of bearers, the DDDS procedure is performed frequently, which consumes the resources of the base stations 1 and 2 (particularly, the base station 1). When more resources are consumed to perform the DDDS procedure, the transmission rate of a user plane may be limited. Note that a plurality of bearers may be configured for one user terminal. For example, for one terminal, a bearer for transporting audio data, a bearer for transporting image data, and a bearer for transporting HTML data may be configured at the same time.

For the above problem, if the cycle of requesting the DDDS report is extended, less resources are consumed to perform the DDDS procedure. Note, however, when the cycle of requesting the DDDS report is extended, the status of the base station 2 may not be estimated accurately. Therefore, a radio communication system according to the embodiment of the present disclosure provides a function of mitigating the above trade-off.

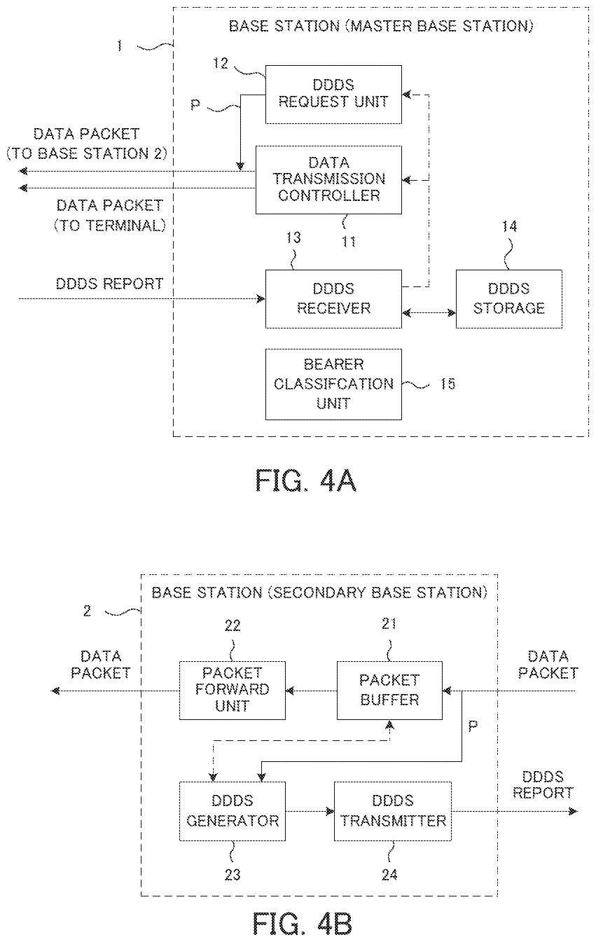

FIG. 4A illustrates an example of the base station 1, which operates as the master base station. The base station 1 includes a data transmission controller 11, a DDDS request unit 12, a DDDS receiver 13, a DDDS storage 14, and a bearer classification unit 15. Note that the base station 1 may include other functions not illustrated in FIG. 4A. FIG. 4A illustrates functions related to the master base station for the dual connectivity communication.

The data transmission controller 11 transmits the downlink data provided from the core network to the base station 2 and the user terminal 3. At this time, the data transmission controller 11 controls the data transmission to the base station 2 based on the DDDS report received from the base station 2. Note that the downlink data is stored in the data packet and transmitted.

The DDDS request unit 12 transmits a report request requesting the DDDS report to the base station 2. The report request is achieved by the polling bit P provided to each data packet transmitted from the base station 1 to the base station 2. Specifically, when requesting the DDDS report, the DDDS request unit 12 sets the polling bit P to “1”. In addition, when not requesting the DDDS report, the DDDS request unit 12 sets the polling bit P to “0”. In other words, the report request is achieved by setting the polling bit P to “1”. Note that the DDDS request unit 12 requests the base station 2 for the DDDS report at a specified cycle, for example. Note that the DDDS request unit 12 may change the cycle of requesting the DDDS report.

The DDDS receiver 13 receives the DDDS report transmitted from the base station 2. The DDDS report received by the DDDS receiver 13 is stored in the DDDS storage 14. Note that the bearer classification unit 15 will be described later.

The data transmission controller 11, DDDS request unit 12, DDDS receiver 13, and bearer classification unit 15 are achieved by, for example, a processor executing a software program. In other words, a processor executing a software program provides functions of the data transmission controller 11, DDDS request unit 12, DDDS receiver 13, and bearer classification unit 15. Note that some of the functions of the data transmission controller 11, DDDS request unit 12, DDDS receiver 13, and bearer classification unit 15 may be achieved by a hardware circuit. In addition, the DDDS storage 14 is achieved by, for example, a semiconductor memory.

FIG. 4B illustrates an example of the base station 2, which operates as the secondary base station. The base station 2 includes a packet buffer 21, a packet forward unit 22, a DDDS generator 23, and a DDDS transmitter 24. Note that the base station 2 may include other functions not illustrated in FIG. 4B. FIG. 4B illustrates functions related to the secondary base station for the dual connectivity communication.

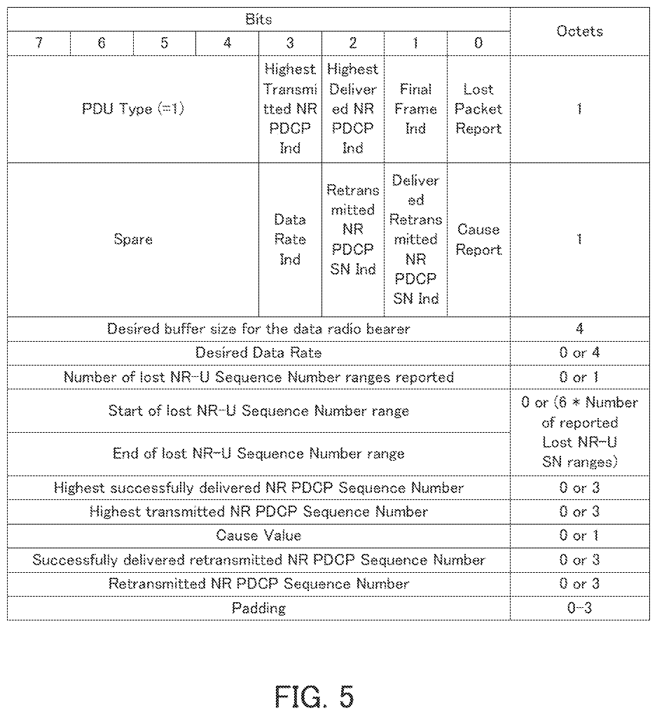

The packet buffer 21 is for example a FIFO memory and stores the data packet received from the base station 1. The packet forward unit 22 transmits the data packet stored in the packet buffer 21 to the user terminal 3. Note that the polling bit P provided to each received packet is fed to the DDDS generator 23. The DDDS generator 23 generates the DDDS report when the base station 2 receives the DDDS request. Then, the DDDS transmitter 24 transmits the DDDS report to the base station 1. Note that the format of the DDDS report is as illustrated in FIG. 5. This format is defined in TS38.425 of 3GPP.

The packet forward unit 22, DDDS generator 23, and DDDS transmitter 24 are achieved by, for example, a processor executing a software program. In other words, a processor executing a software program provides functions of the packet forward unit 22, DDDS generator 23, and DDDS transmitter 24. Note that some of the functions of the packet forward unit 22, DDDS generator 23, and DDDS transmitter 24 may be achieved by a hardware circuit. In addition, the packet buffer 21 is achieved by, for example, a semiconductor memory.

### First Embodiment

The base station 1, which operates as the master device, transmits the DDDS request to the base station 2, which operates as the secondary base station, as described above. The base station 2 generates and transmits the DDDS report to the base station 1 and the base station 1 receives the DDDS report. In the base station 1, the received DDDS report is stored in the DDDS storage 14. During this process, the DDDS report is generated for each bearer in the base station 2 and stored in the base station 1 for each bearer.

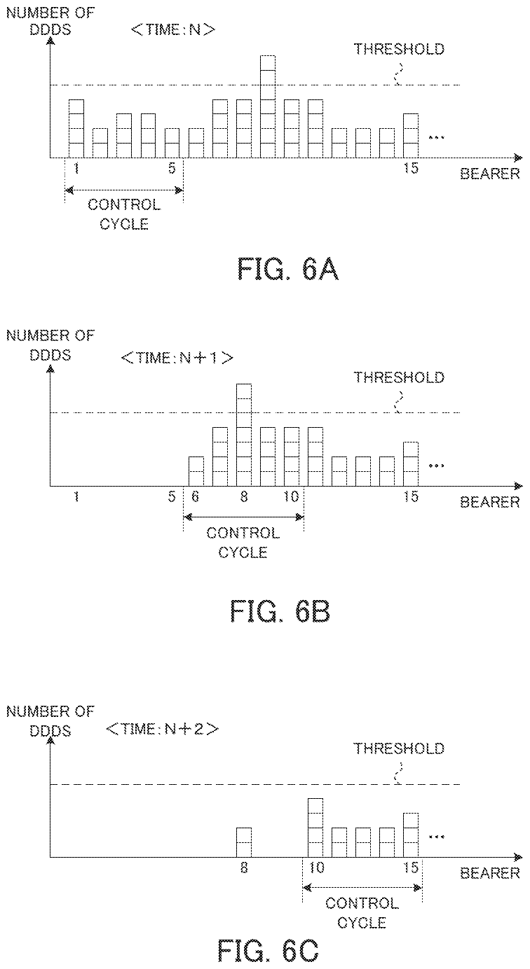

FIGS. 6A-6C illustrate an example of the DDDS procedure according to a first embodiment of the present disclosure. Note that each rectangle symbol illustrated in FIGS. 6A-6C indicates the DDDS report stored in the DDDS storage 14. In addition, in this example, it is assumed that the base station 1 performs a flow control for five bearers at each processing timing.

As illustrated in FIG. 6A, at time N, the data transmission controller 11 performs the flow control for each of the bearers 1 to 5. At this time, the data transmission controller 11 reads the DDDS report for the bearers 1 to 5 from the DDDS storage 14 and performs the flow control based on each DDDS report. For example, at time N, four DDDS reports are stored for the bearer 1. In this case, the data transmission controller 11 performs the flow control for the bearer 1 based on the four DDDS reports.

Note that the number of DDDS reports that the data transmission controller 11 may perform for each bearer in one control cycle is limited. In this example, the number of DDDS reports that the data transmission controller 11 may perform for each bearer is five.

As illustrated in FIG. 6B, at time N+1, the data transmission controller 11 performs the flow control for each of the bearers 6 to 10. Note that seven DDDS reports are stored for eight bearers. In this case, the data transmission controller 11 performs the flow control for the bearer 8 based on five DDDS reports. In other words, two DDDS reports are not read out from the DDDS storage 14.

As illustrated in FIG. 6C, at time N+2, the data transmission controller 11 performs the flow control for each of the bearers 11 to 15. At this time, the DDDS report for the bearer 8 that was not read out at time N+1 remains in the DDDS storage 14. The DDDS report left in the DDDS storage 14 will be performed at the next processing timing for the bearers 6 to 10. In other words, the processes related to the DDDS procedure are distributed in the time domain.

As described above, in the first embodiment, the number of DDDS reports read out from the DDDS storage 14 for the flow control is limited, and so the processor resources consumed to perform the DDDS procedure in the base station 1 are reduced. In other words, sufficient processor resources are allocated for the processes of the user plane. Therefore, the user throughput is improved.

### Second Embodiment

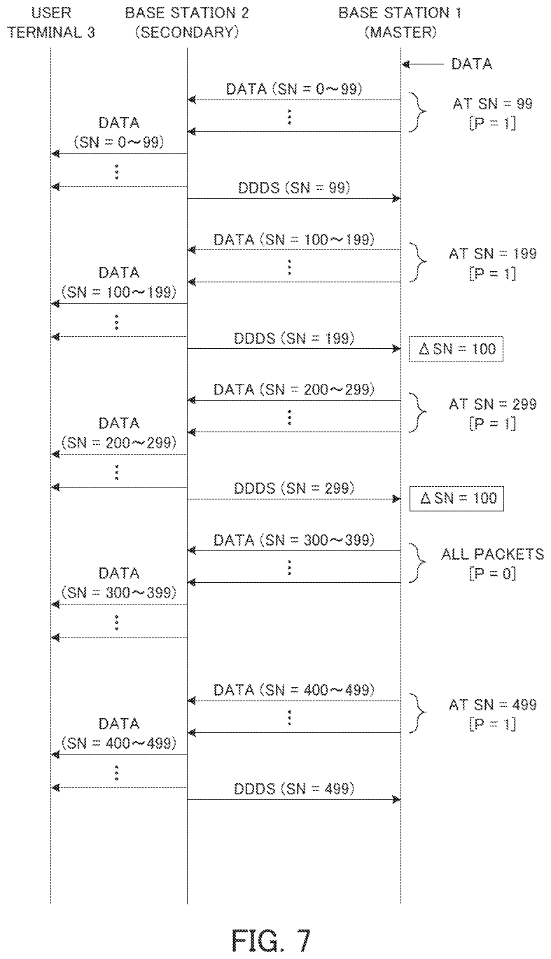

FIG. 7 illustrates an example of the DDDS procedure according to a second embodiment of the present disclosure. Note that FIG. 7 omits the direct data transmission from the base station 1 to the user terminal 3. Likewise, the following description of embodiments may also omit the direct data transmission from the base station 1 to the user terminal 3.

The base station 1 transmits the data packet to the base station 2. Each data packet is provided with a sequence number SN and the polling bit P. The sequence number SN identifies each data packet. Therefore, the base station 2 may detect the packet loss using the sequence number SN. In the following description, a data packet having a sequence number SN of “i” may be referred to as a “packet SNi”. In addition, the polling bit P indicates whether to request the DDDS report, as described above. Specifically, when the polling bit is “0”, the base station 2 transmits no DDDS report to the base station 1. When the polling bit is “1”, the base station 2 transmits the DDDS report to the base station 1.

The polling bit P is set to “1” at a specified cycle. In this example, when transmitting 100 data packets, “P=1” is set for one data packet. For example, when transmitting 100 packets (SN0 to SN99), “P=0” is provided to the packets SN0 to SN98 and “P=1” is provided to the packet SN99.

The base station 2 forwards the data packet received from the base station 1 to the user terminal 3. For example, when receiving the packets SN0 to SN99, the base station 2 forwards the packets SN0 to SN99 to the user terminal 3.

In addition, when receiving the DDDS request, the base station 2 generates and transmits the DDDS report to the base station 1. In other words, when receiving the data packet with “P=1”, the base station 2 generates and transmits the DDDS report to the base station 1. In this example, when receiving the packet SN99, the base station 2 generates and transmits the DDDS report to the base station 1.

The DDDS report includes the information illustrated in FIG. 5. In the second embodiment, the sequence number SN of the data packet that the base station 2 finally forwards to the user terminal 3 is used. Specifically, the sequence number SN of the data packet that the base station 2 finally forwards to the user terminal 3 is reported to the base station 1 from the base station 2 as “Highest successfully delivered NR PDCP Sequence Number” or “Highest transmitted NR PDCP Sequence Number”. In this example, the base station 2 forwards the packets SN0 to SN99 to the user terminal 3. Therefore, the DDDS report reports “SN=99” to the base station 1.

Next, the base station 1 transmits the packets SN100 to SN199 to the base station 2. During this process, “P=0” is provided to the packets SN100 to SN198 and “P=1” is provided to the packet SN199. Here, it is assumed that the base station 2 forwards all of the packets SN100 to SN199 to the user terminal 3. In this case, the sequence number SN of the data packet that the base station 2 finally forwards to the user terminal 3 is “199”. Therefore, the DDDS report reports “SN=199” to the base station 1.

The base station 1 calculates the difference ΔSN between the sequence number SN reported by the new DDDS report and the sequence number SN reported by the immediately previous DDDS report. In this example, the difference ΔSN is 100.

Likewise, the base station 1 transmits the packets SN200 to SN299 to the base station 2. During this process, “P=0” is provided to the packets SN200 to SN298 and “P=1” is provided to the packet SN299. Here, it is assumed that the base station 2 forwards all of the packets SN200 to SN299 to the user terminal 3. In this case, the sequence number SN of the data packet that the base station 2 finally forwards to the user terminal 3 is “299”. Therefore, the DDDS report reports “SN=299” to the base station 1.

The base station 1 calculates the difference ΔSN. In this example, the difference ΔSN is 100. Additionally, the base station 1 calculates the change in the difference ΔSN. In this example, the previous difference ΔSN and the new difference ΔSN are the same. In this case, the base station 1 estimates that the radio environment between the base station 2 and the user terminal 3 is stable. Here, it is considered that when the radio environment between the base station 2 and the user terminal 3 is stable, the base station 1 may accurately estimate the status of the data transmission between the base station 2 and the user terminal 3 even for a lower frequency of the flow control based on the DDDS report. And when the status of the data transmission between the base station 2 and the user terminal 3 can be estimated accurately, an appropriate flow control is possible. Therefore, if the previous difference ΔSN and the new difference ΔSN are the same, the base station 1 extends the cycle of requesting the DDDS report. In other words, the base station 1 extends the cycle of transmitting the DDDS request.

Note that although in the above described example, the transmission cycle of the DDDS request is extended when the value of the difference ΔSN is the same for two consecutive times, the second embodiment is not limited to this method. In other words, the transmission cycle of the DDDS request may be extended, when the value of the difference ΔSN is the same for a specified number of consecutive times. In addition, although in the above described example, the transmission cycle of the DDDS request is extended when the change in the difference ΔSN is zero, the second embodiment is not limited to this method. In other words, if the change in the difference ΔSN is less than a specified threshold, the transmission cycle of the DDDS request may be extended.

In this example, the transmission cycle of the DDDS request is extended from “100 packets” to “200 packets”. Therefore, when transmitting the packets SN300 to SN399, “P=0” is provided to all data packets. In this case, the base station 2 generates no DDDS report. Next, when transmitting the packets SN400 to SN499, “P=0” is provided to the packets SN400 to SN498 and “P=1” is provided to the packet SN499. And when receiving the packet SN499, the base station 2 generates and transmits the DDDS report to the base station 1.

As described above, in the second embodiment, the base station 1 extends the cycle of requesting the DDDS report when the radio environment between the base station 2 and the user terminal 3 is stable. Thus, the base station 1 receives the DDDS report less frequently and the DDDS procedure based on the DDDS report is performed less frequently. Therefore, the processor resources consumed to perform the DDDS procedure in the base station 1 are reduced. In other words, sufficient processor resources are allocated for the processes of the user plane, which improves the data throughput.

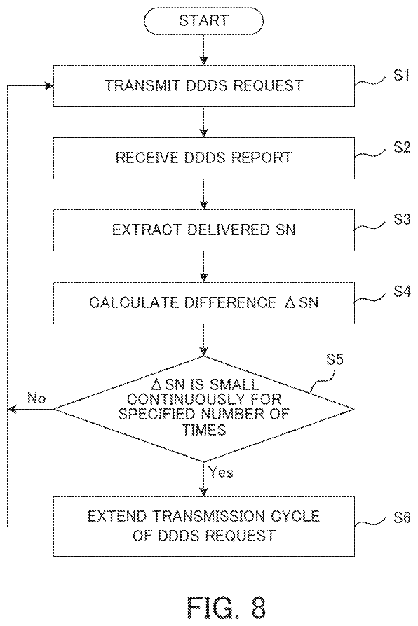

FIG. 8 is a flowchart illustrating an example of the operation of the master base station (base station 1) in the second embodiment. Note that FIG. 8 omits the process of transmitting the downlink data.

In S1, the DDDS request unit 12 transmits the DDDS request to the base station 2. The DDDS request is achieved by the polling bit. In addition, the DDDS request is transmitted at a specified cycle.

In S2, the DDDS receiver 13 receives the DDDS report. In S3, the DDDS request unit 12 extracts the delivered SN from the DDDS report. Here, the delivered SN indicates the sequence number that identifies the data packet that the base station 2 finally forwards to the user terminal 3. In S4, the DDDS request unit 12 calculates the difference ΔSN. The difference ΔSN indicates the difference between the newly extracted delivered SN and the previous delivered SN.

In S5, the DDDS request unit 12 determines whether the difference ΔSN is less than a threshold for a specified number of consecutive times. If this determination result is “No”, then the process of the base station 1 returns to S1. In this case, the cycle at which the base station 1 transmits the DDDS request remains unchanged. In contrast, if the difference ΔSN is less than the threshold for a specified number of consecutive times, the DDDS request unit 12 extends the transmission cycle of the DDDS request in S6. Then, the process of the base station 1 returns to S1. In this case, the base station 1 will transmit the DDDS request at a longer cycle than the initial value.

### Third Embodiment

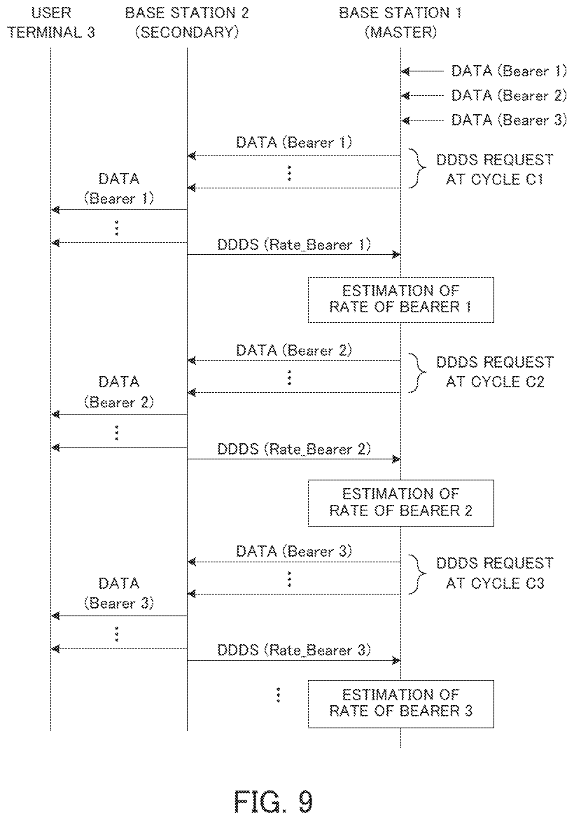

FIG. 9 illustrates an example of the DDDS procedure according to a third embodiment of the present disclosure. In this example, three bearers are configured. These bearers may be connections that transmit the downlink data to the same user terminal or connections that transmit the downlink data to different user terminals.

The base station 1 transmits the data packet of the bearer 1 to the base station 2. At this time, the base station 1 transmits the DDDS request to the base station 2 at a specified cycle C1. Then, in response to the DDDS request, the base station 2 transmits the DDDS report related to the bearer 1 to the base station 1. Likewise, the base station 1 transmits the DDDS request for the bearer 2 to the base station 2 at a specified cycle C2, and the base station 2 transmits the DDDS report related to the bearer 2 to the base station 1. The base station 1 also transmits the DDDS request for the bearer 3 to the base station 2 at a specified cycle C3, and the base station 2 transmits the DDDS report related to the bearer 3 to the base station 1. Note that the cycles C1 to C3 may or may not be the same as each other.

The base station 1 estimates, for each bearer, the radio rate between the base station 2 and the corresponding user terminal. Note that the method of estimating the radio rate from the DDDS report illustrated in FIG. 5 is a well-known technology and thus its description is omitted here. Then, the base station 1 estimates the radio rate for each bearer each time it receives the DDDS report. And the base station 1 monitors the change of the radio rate for each bearer.

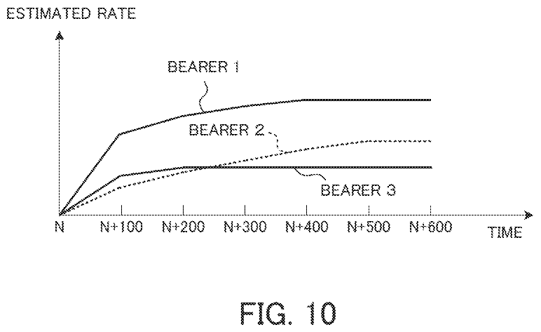

FIG. 10 illustrates an example of the radio rate estimated based on the DDDS report. In this example, the estimated radio rate for the bearer 1 is almost constant after time N+400. The estimated radio rate for the bearer 2 is almost constant after time N+500. The estimated radio rate for the bearer 3 is almost constant after time N+200.

Here, when a plurality of bearers are configured and the radio condition between the base station 2 and the user terminal becomes stable, the ratio of the radio bandwidth allocated to each bearer becomes almost constant. Specifically, when the radio condition between the base station 2 and the user terminal becomes stable, the radio rate for each bearer becomes almost constant. In other words, when the variation in the radio rate for each bearer is less than a specified threshold, it is estimated that the radio condition between the base station 2 and the user terminal is stable.

Therefore, when the variation in the radio rate for each bearer is less than a specified threshold, the base station 1 extends the transmission cycle of the DDDS request. For example, after time N+500, the estimated radio rates for the bearers 1 to 3 are almost constant. In this case, the base station 1 makes the transmission cycles of the DDDS requests for the bearers 1 to 3 longer than C1 to C3, respectively.

Alternatively, the base station 1 may change the transmission cycle of the DDDS request for each bearer. For example, the transmission cycle of the DDDS request for the bearer 1 may be set longer than C1 at time N+400, the transmission cycle of the DDDS request for the bearer 2 may be set longer than C2 at time N+500, and the transmission cycle of the DDDS request for the bearer 3 may be set longer than C3 at time N+200.

As described above, also in the third embodiment, the base station 1 extends the cycle of requesting the DDDS report when the radio environment between the base station 2 and the user terminal 3 is stable. Therefore, like the second embodiment, also in the third embodiment, the processor resources consumed to perform the DDDS procedure in the base station 1 are reduced.

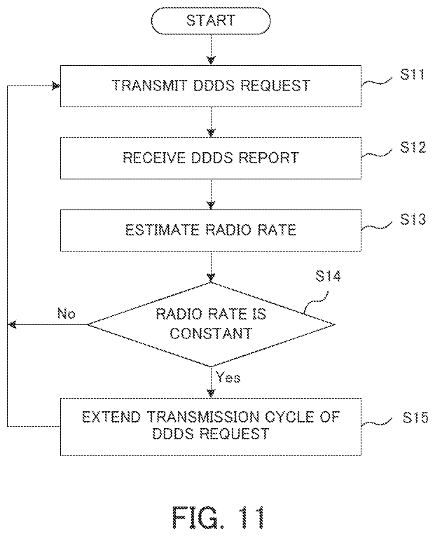

FIG. 11 is a flowchart illustrating an example of the operation of the master base station (base station 1) in the third embodiment. Note that FIG. 11 omits the process of transmitting the downlink data.

S11 to S12 are substantially the same as S1 to S2 illustrated in FIG. 8. In other words, the DDDS request unit 12 transmits, for each bearer, the DDDS request to the base station 2 at a specified cycle. Then, the DDDS receiver 13 receives the DDDS report.

In S13, the base station 1 estimates, for each bearer, the radio rate between the base station 2 and the user terminal based on the DDDS report. In S14, the base station 1 determines whether the radio rate is constant. Here, “constant” includes the status in which the variation of the radio rate is less than a specified threshold.

If the variation of the radio rate is not constant, the process of the base station 1 returns to S11. In this case, the cycle at which the base station 1 transmits the DDDS request remains unchanged. In contrast, if the radio rate becomes constant or almost constant, the DDDS request unit 12 extends the transmission cycle of the DDDS request in S15. Then, the process of the base station 1 returns to S11. In this case, the base station 1 will transmit the DDDS request at a longer cycle than the initial value.

### Fourth Embodiment

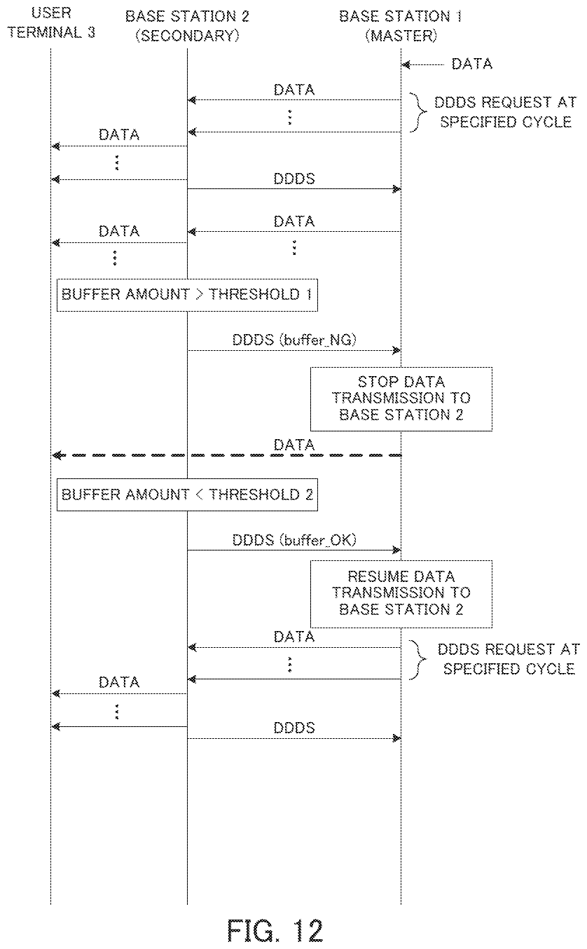

FIG. 12 illustrates an example of the DDDS procedure according to a fourth embodiment of the present disclosure. Also in the fourth embodiment, the base station 1 transmits the DDDS request to the base station 2 at a specified cycle. The base station 2 transmits the DDDS report to the base station 1 in response to the DDDS request. Then, the base station 1 performs the flow control based on the DDDS report.

In the base station 2, the data packet received from the base station 1 is stored in the packet buffer 21 illustrated in FIG. 4B. Then, the packet forward unit 22 reads the data packet from the packet buffer 21 and transmits it to the user terminal 3. At this time, the DDDS generator 23 always monitors the amount of the data packet stored in the packet buffer 21 (hereinafter, the buffer amount). And if the buffer amount exceeds a specified threshold TH1, the DDDS generator 23 autonomously generates the DDDS report and transmits it to the base station 1. In other words, in this case, even when no DDDS request is received from the base station 1, the DDDS report is generated autonomously. This DDDS report is used to report to the base station 1 that the buffer amount exceeds the threshold.

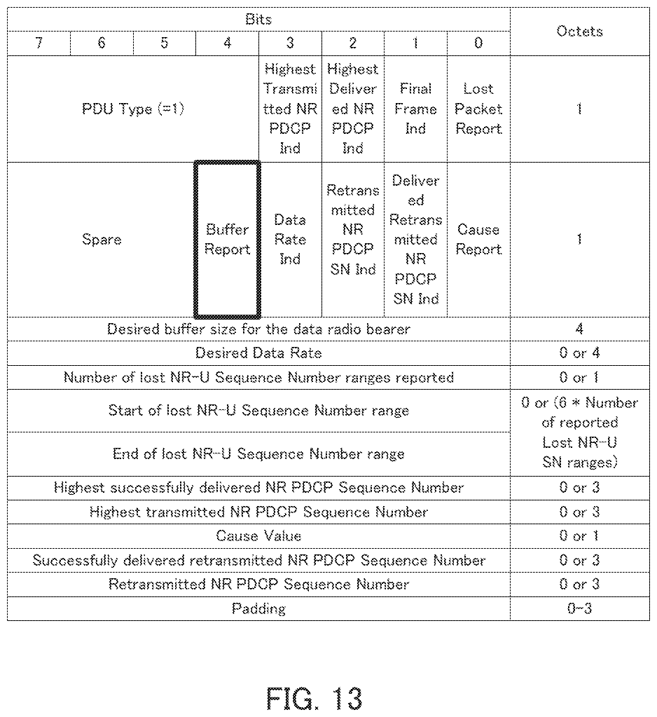

In this example, reporting that the buffer amount exceeds the threshold is achieved by setting “buffer report bit (Buffer Report)” illustrated in FIG. 13 to “1”. Note that the buffer report bit is set using the unused area in the format illustrated in FIG. 5.

When recognizing that the buffer amount of the base station 2 exceeds the threshold, the base station 1 stops the data transmission to the base station 2. In this case, the base station 1 transmits the data packet only to the user terminal 3. Note that each data packet includes a polling bit P and this polling bit P is used as a DDDS request. Thus, when the base station 1 stops the data transmission to the base station 2, transmission of the DDDS request to the base station 2 is also stopped. That is, when the buffer amount of the base station 2 exceeds the threshold, the base station 1 stops the transmission of the DDDS request to the base station 2.

The base station 2 continues to forward the data to the user terminal 3. Therefore, if the data transmission from the base station 1 to the base station 2 is stopped, the buffer amount will be decreased. And when the buffer amount is less than a specified threshold TH2, the DDDS generator 23 autonomously generates the DDDS report and transmits it to the base station 1. This DDDS report is used to report to the base station 1 that the buffer amount is less than the threshold. In addition, this report is achieved by setting the above described buffer report bit to “0”. Note that the thresholds TH1 and TH2 may be the same as each other or the threshold TH2 may be smaller than the threshold TH1. Then, when the base station 1 recognizes that the buffer amount of the base station 2 is less than the threshold, it resumes the data transmission to the base station 2. The base station 1 also resumes the transmission of the DDDS request.

As described above, in the fourth embodiment, when the data transmission amount from the base station 1 to the base station 2 exceeds the capacity of the base station 2, the flow control is achieved without polling. Therefore, the processes related to the DDDS procedure may be reduced.

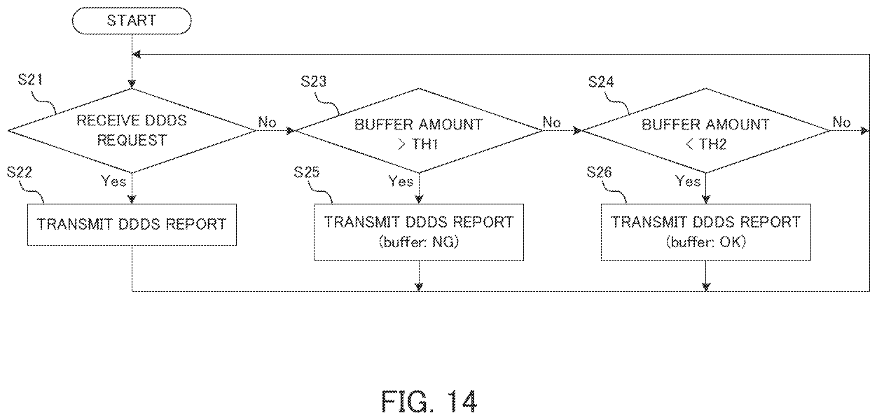

FIG. 14 is a flowchart illustrating an example of the operation of the secondary base station (base station 2) in the fourth embodiment. Note that FIG. 14 depicts only the steps related to the process of transmitting the DDDS report.

In S21, the base station 2 checks whether it receives the DDDS request from the base station 1. If the base station 2 receives the DDDS request, the DDDS generator 23 generates the DDDS report illustrated in FIG. 5 and the DDDS transmitter 24 transmits the DDDS report to the base station 1 in S22.

When the base station 2 does not receive the DDDS request, the DDDS generator 23 monitors the buffer amount in S23 and S24. If the buffer amount exceeds the threshold TH1, the DDDS generator 23 generates the DDDS report illustrated in FIG. 13 in S25. At this time, the buffer report bit is set to “1 (NG)”. Then, the DDDS transmitter 24 transmits this DDDS report to the base station 1. In contrast, if the buffer amount is less than the threshold TH2, the DDDS generator 23 generates the DDDS report illustrated in FIG. 13 in S26. At this time, the buffer report bit is set to “0 (OK)”. Then, the DDDS transmitter 24 transmits this DDDS report to the base station 1.

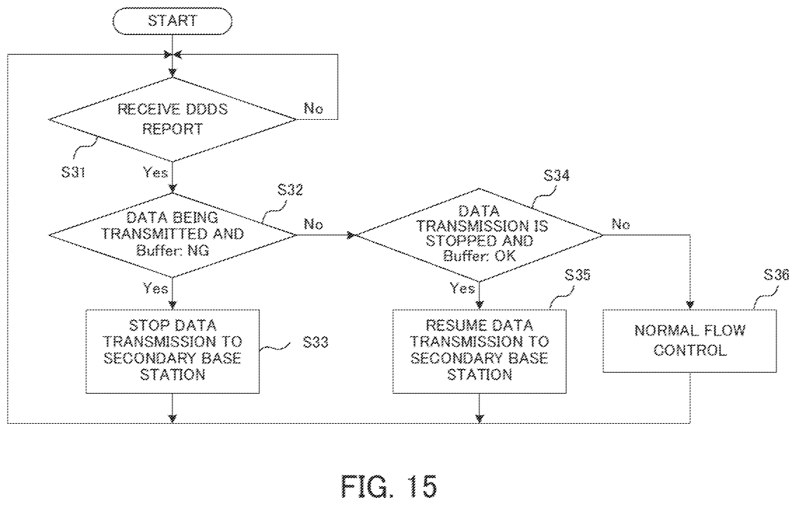

FIG. 15 is a flowchart illustrating an example of the operation of the master base station (base station 1) in the fourth embodiment. Note that FIG. 15 omits the process of transmitting the DDDS request.

In S31, the DDDS receiver 13 is waiting for the DDDS report transmitted from the base station 2. Note that when the base station 1 is transmitting the data packet to the base station 2, the DDDS request is transmitted to the base station 2 at a specified cycle, and so the base station 1 will receive the DDDS report periodically.

When the DDDS receiver 13 receives the DDDS report, the base station 1 determines in S32 whether the data transmission controller 11 is transmitting the data packet to the base station 2 and the buffer report bit of the DDDS report indicates “NG (buffer amount>threshold)”. Then, if the above two conditions are satisfied, the data transmission controller 11 stops the data transmission to the base station 2 in S33. Note that the data transmission controller 11 may continue the data transmission to the user terminal 3.

If the determination is “No” in S32, then the base station 1 determines in S34 whether the data transmission controller 11 stops the data transmission to the base station 2 and the buffer report bit of the DDDS report indicates “OK (buffer amount<threshold)”. If the above two condition are satisfied, the data transmission controller 11 resumes the data transmission to the base station 2 in S35. In contrast, if the determination is “No” in S34, the data transmission controller 11 performs the normal flow control in S36.

### Fifth Embodiment

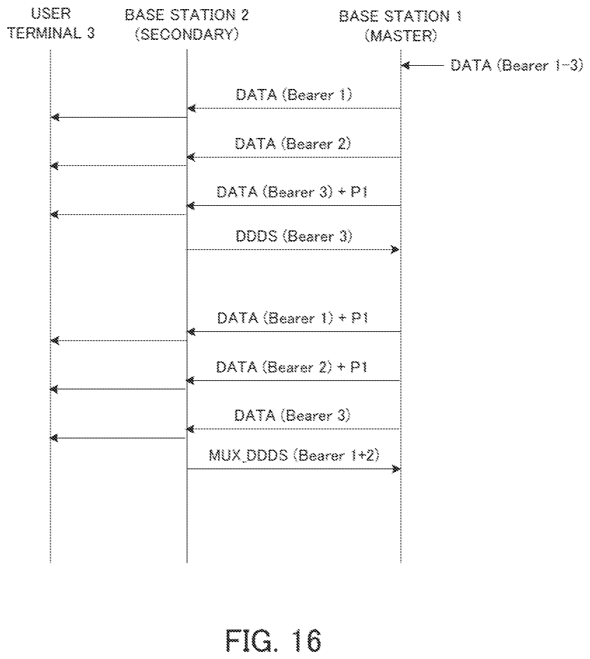

FIG. 16 illustrates an example of the DDDS procedure according to a fifth embodiment of the present disclosure. In the fifth embodiment, a plurality of bearers (1 to 3) are configured. In other words, the base station 1 transmits the data packet to the base station 2 for each bearer. The base station 1 also transmits, for each bearer, the DDDS request to the base station 2 at a specified cycle. Note that FIG. 16 represents the DDDS request as “P1”.

For example, when the base station 1 transmits the DDDS request for the bearer 3, the base station 2 generates the DDDS report corresponding to bearer 3 and transmits it to the base station 1. At this time, the base station 2 transmits, for example, the DDDS report in the format illustrated in FIG. 5 to the base station 1.

Here, the timings of transmitting the DDDS request to each bearer are not synchronized with each other, and so the DDDS requests may be transmitted for a plurality of bearers in a short period. In other words, the base station 2 may receive the DDDS requests for a plurality of bearers in a short period. In this case, the base station 2 transmits to the base station 1 a DDDS report in which a plurality of bearers are multiplexed.

For example, as illustrated in FIG. 16, it is assumed that the base station 1 transmits to the base station 2 the DDDS request for the bearer 1 and the DDDS request for the bearer 2 at almost the same time. In this case, the base station 2 receives the DDDS request for the bearer 1 and the DDDS request for the bearer 2 at almost the same time. Then, the base station 2 generates a DDDS report (MUX_DDDS) in which bearers 1 and 2 are multiplexed and transmits it to the base station 1.

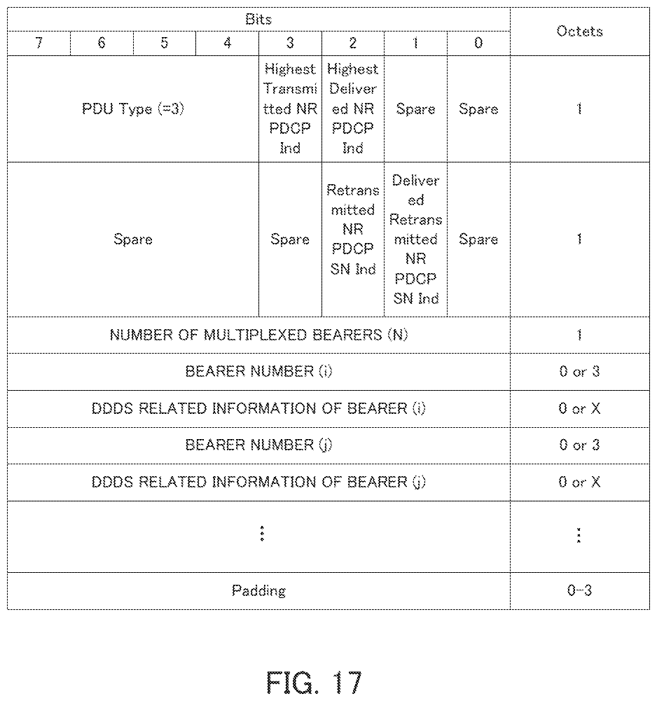

FIG. 17 illustrates an example of a format of the DDDS report that may multiplex a plurality of bearers. The number of multiplexed bearers indicates the number of bearers multiplexed in one DDDS report. For example, in the case illustrated in FIG. 16, the bearers 1 and 2 are multiplexed and so the number N of multiplexed bearers is 2. The bearer number identifies the multiplexed bearers. The DDDS related information corresponds to, for example, the information illustrated in FIG. 5. Note that this format may be added in TS38.425 of 3GPP as, for example, PDU Type3.

Note that although the format illustrated in FIG. 17 is used when a plurality of bearers are multiplexed, it may be used in transporting the DDDS report for one bearer. In this case, the number N of multiplexed bearers is 1.

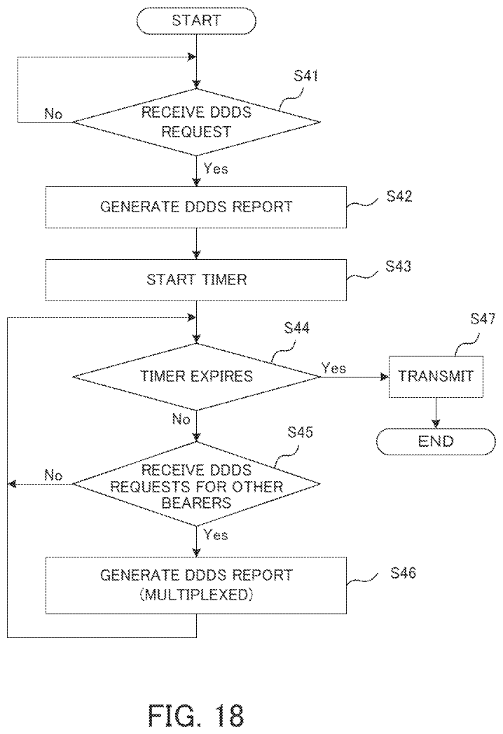

FIG. 18 is a flowchart illustrating an example of the operation of the secondary base station (base station 2) in the fifth embodiment. Note that FIG. 18 depicts only the steps related to the process of transmitting the DDDS report.

In S41, the base station 2 is waiting for the DDDS request transmitted from the base station 1. When receiving the DDDS request, the DDDS report generator 23 generates the DDDS report in response to the DDDS request in S42. The DDDS report generator 23 starts a timer in S43. This timer counts the period of waiting for the DDDS request for other bearers.

In S44 and S45, the base station 2 is waiting for the DDDS request for other bearers. And when the base station 2 receives the DDDS request for other bearers before the timer expires, the DDDS report generator 23 generates the DDDS report in S46. At this time, the new DDDS report is added in the format illustrated in FIG. 17. The multiplexing of bearers is thus achieved. And when the timer expires, the DDDS transmitter 24 transmits the DDDS report to the base station 1 in S47.

As described above, the secondary base station in the fifth embodiment may transmit a DDDS report in which a plurality of bearers are multiplexed. This reduces the number of times the master base station receives the DDDS report, thus reducing the processor resources consumed to perform the DDDS procedure in the master base station.

Note that if the timer setting time is increased, the number of bearers multiplexed in one DDDS report increases, and the efficiency of the DDDS related processing may be improved. However, if the timer setting time is set too long, a flow control delay is likely to occur and the transmission rate may not be properly controlled. Therefore, it is preferable to properly determine the timer setting time in consideration of these factors.

### Sixth Embodiment

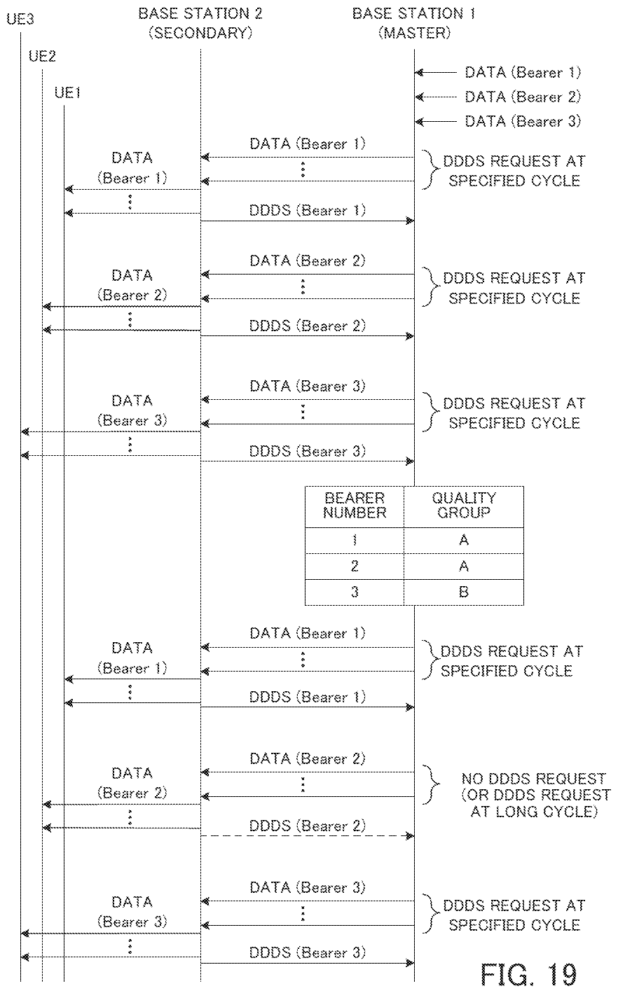

FIG. 19 illustrates an example of the DDDS procedure according to a sixth embodiment of the present disclosure. In the sixth embodiment, bearers 1 to 3 are set. The bearers 1 to 3 transport the downlink data to different user terminals. In this example, the bearers 1 to 3 transport the downlink data to the user terminals UE1 to UE3, respectively.

In this case, the radio quality of each bearer depends on the position of the user terminal. For example, when the user terminal is located close to the base station, the radio quality is likely to be high, and when the user terminal is located at the cell end, the radio quality is likely to be low.

In the sixth embodiment, the base station 1 estimates the radio quality of each bearer. In other words, the base station 1 estimates the radio quality between the base station 2 and each user terminal. The radio quality of each bearer is estimated by well-known technologies. For example, the radio quality of each bearer may be estimated based on the DDDS report. Then the base station 1 groups the bearers based on the radio quality. In this example, the bearers 1 to 2 are classified into the quality group A and the bearer 3 is classified into the quality group B. Note that the bearers are grouped by the bearer classification unit 15 illustrated in FIG. 4A.

Here, it is estimated that the states of the bearers belonging to the same quality group are close to each other. In the example illustrated in FIG. 19, it is estimated that the states of the bearers 1 and 2 are close to each other. Thus, the base station 1 may perform the flow control for each quality group. Therefore, the base station 1 selects a representative bearer in each quality group. Then, by obtaining the DDDS report for the representative bearer, the base station 1 performs the flow control for each of the bearers belonging to the same quality group.

For example, it is assumed that the bearer 1 is selected as the representative bearer in the quality group A. In this case, the base station 1 transmits the DDDS request for the bearer 1 to the base station 2 at a specified cycle, but it does not transmit the DDDS request for the bearer 2. Then, the base station 2 transmits the DDDS report for the bearer 1 to the base station 1. Then, the base station 1 performs the flow control for the bearers 1 and 2 based on the DDDS report for the bearer 1. This reduces the processes related to the DDDS procedure.

Note that in the above described example, only the DDDS request for the representative bearer is transmitted, but the sixth embodiment is not limited to this method. For example, in comparison to the cycle of transmitting the DDDS request for the representative bearer, the cycle of transmitting the DDDS request for other bearers may be extended.

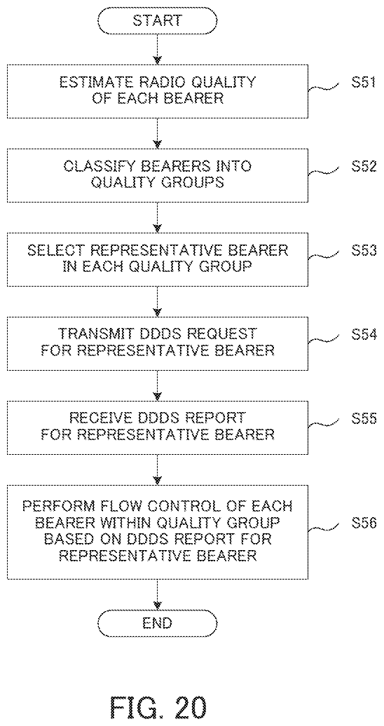

FIG. 20 is a flowchart illustrating an example of the operation of the master base station (base station 1) in the sixth embodiment. Note that FIG. 20 depicts only the steps related to the DDDS procedure.

In S51, the bearer classification unit 15 estimates the radio quality of each bearer. In S52, the bearer classification unit 15 groups the bearers based on the radio quality. In other words, the bearers are classified into the quality groups. In S53, the bearer classification unit 15 selects a representative bearer in each quality group. In S54, the DDDS request unit 12 transmits the DDDS request for the representative bearer to the base station 2. In S55, the DDDS receiver 13 receives the DDDS report for the representative bearer from the base station 2. Then, in S56, the data transmission controller 11 performs the flow control for each bearer in the quality group based on the DDDS report for the representative bearer.

### Effects of Embodiments of Present Disclosure

As described above, according to the embodiments of the present disclosure, the DDDS related processing is distributed (or averaged) in the time domain. In addition, the DDDS multiplexing may reduce the number of DDDS reports per unit time. Additionally, a flow control per radio quality may reduce the DDDS related processing.

For example, it is assumed that if no distributed processing is performed, the load of the user plane corresponds to percent of the CPU resources, and the load of the DDDS processes also corresponds to 80 percent of the CPU resources. In this case, insufficient CPU resources are allocated to the user plane, decreasing the data throughput. In contrast, it is assumed that averaging the DDDS processes in the time domain may reduce the load of the DDDS processes at peak to, for example, 20 percent of the CPU resources. As a result, sufficient CPU resources may be allocated to the user plane, improving the data throughput.

In addition, by way of example, if the data rate of the downlink is 5 Gbps, the SDU length is 1500 byte, and the radio communication system accommodates one bearer, PPS per 1000 milliseconds is about 417000 packets. In contrast, the DDDS requires about 200 packets of PPS. In other words, the load of the DDDS related processing is small. However, if the radio communication system accommodates 1000 bearers, DDDS requires about 200000 packets of PPS. In other words, the load of the DDDS related processing corresponds to about 50 percent of the load of the user plane. In contrast, for example, if 10 bearers are multiplexed for one DDDS report, the load of the DDDS related processing is reduced to about five percent of the load of the user plane.

When a flow control is performed per bearer, processes proportional to the number of accommodated bearers are generated. In contrast, a flow control per quality group may greatly reduce the amount of processes. For example, if the radio communication system accommodates 1000 bearers and 10 quality groups are configured, the amount of the DDDS related processing may be reduced to about one hundredth.

As a result, sufficient CPU resources may be allocated to the user plane, improving the data throughput.

All examples and conditional language provided herein are intended for the pedagogical purposes of aiding the reader in understanding the disclosure and the concepts contributed by the inventor to further the art, and are not to be construed as limitations to such specifically recited examples and conditions, nor does the organization of such examples in the specification relate to a showing of the superiority and inferiority of the disclosure. Although one or more embodiments of the present disclosures have been described in detail, it should be understood that the various changes, substitutions, and alterations could be made hereto without departing from the spirit and scope of the disclosure.

What is claimed is:

1. A base station device that transmits data to a terminal using an adjacent base station, the base station device comprising:
a receiver configured to receive from the adjacent base station a status report indicating a status of a data transmission from the adjacent base station to the terminal;
a storage configured to store the status report received by the receiver; and
a processor configured to control a data transmission to the adjacent base station based on the status report stored in the storage at each processing timing provided at a specified cycle, wherein
when an amount of the status report stored in the storage exceeds a specified threshold at a first processing timing, the processor controls the data transmission to the adjacent base station based on a part of the status report stored in the storage, and controls the data transmission to the adjacent base station based on a remaining status report at a second processing timing that is later than the first processing timing.

2. A base station device that transmits data to a terminal using an adjacent base station, the base station device comprising:
a processor configured to
transmit, to the adjacent base station at a specified cycle, a report request that requests a status report indicating a status of a data transmission from the adjacent base station to the terminal, and
control a data transmission to the adjacent base station based on the status report received from the adjacent base station, wherein
the processor changes the cycle of transmitting the report request to the adjacent base station based on a change in the status indicated by the status report.

3. The base station device according to claim 2, wherein
a sequence number is provided to a packet transmitted from the base station device to the adjacent base station,
the status report indicates the sequence number of a packet that has been forwarded to the terminal when the adjacent base station receives the report request,
the processor transmits the report request at a first cycle and calculates a difference between the sequence numbers indicated by two consecutive status reports received from the adjacent base station, and
when a change in the difference of the sequence numbers is less than a specified threshold, the processor transmits the report request at a second cycle that is longer than the first cycle.

4. The base station device according to claim 2, wherein
when the processor transmits the report request at a first cycle and a change in a transmission rate between the adjacent base station and the terminal estimated based on the status report is less than a specified threshold, the processor transmits the report request at a second cycle that is longer than the first cycle.

5. A radio communication system in which a first base station and a second base station are connected to a terminal, wherein
the first base station includes a first processor configured to
transmit, to the second base station at a specified cycle, a report request that requests a status report indicating a status of a data transmission from the second base station to the terminal, and
control a data transmission to the second base station based on the status report received from the second base station,
the second base station includes:
a data storage configured to store data received from the first base station; and
a second processor configured to
forward the data stored in the data storage to the terminal, and
transmit the status report to the first base station when receiving the report request,
when the second base station transmits to the first base station a status report indicating that an amount of data stored in the data storage exceeds a specified threshold, the first processor stops transmission of a report request to the second base station.

6. The radio communication system according to claim 5, wherein
when the second base station transmits to the first base station the status report indicating that an amount of data stored in the data storage exceeds the specified threshold, the first processor stops data transmission to the second base station.

7. The radio communication system according to claim 5, wherein
when the second base station transmits to the first base station a status report indicating that an amount of data stored in the data storage is equal to or less than the threshold, the first processor resumes transmission of the report request to the second base station.
